(19) United States
(12) Patent Application Publication
(10) Pub. No.: US 2008/0164724 A1
(43) Pub. Date: Jul. 10, 2008

(54) INTEGRATED PULLOUT STEP SYSTEM FOR TOP BUNK INGRESS/EGRESS

(75) Inventors: Bruce B. Burnett, City Island, NY (US); Andrew Chang, Dallas, TX (US); Neal Johnston, Little Rock, AR (US); Raymond Terza, Havertown, PA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company,, Warrenville, IL (US)

(21) Appl. No.: 11/956,503

(22) Filed: Dec. 14, 2007

Related U.S. Application Data
(60) Provisional application No. 60/883,087, filed on Jan. 2, 2007.

(51) Int. Cl. A47B 85/08; A47B 46/00; A47B 83/00; B62D 33/06; B60P 3/32

(52) U.S. Cl. 296/190.02; 182/38; 182/35; 312/235.1; 312/237

(57) ABSTRACT

A truck (136) has a sleeper cab (138) in which a bunk (140) is elevated from a floor (72) of the cab. A cabinet (110) is adjacent an end of the bunk. A track (146, 148) runs on the cab floor from inside the cabinet to outside the cabinet. A set of stairs (42; 242) are movable along the track from a non-deployed position inside the cabinet to a deployed position that allows a person to ascend and descend the stairs for climbing up into and climbing down from the bunk. A releasable locking system (150) locks the stairs in the deployed and non-deployed positions. A handle (158) can be pulled to unlock the stairs from non-deployed position and move them to deployed position. The handle can be pushed to unlock the stairs from deployed position and move them to non-deployed position.

### REFERENCE TO RELATED APPLICATION AND PRIORITY CLAIM

This application claims the priority of Provisional Patent Application No. 60/883,087, filed on 2 Jan. 2007, the entire content of which is incorporated herein by reference.

### FIELD OF THE INVENTION

This invention relates to a truck having a sleeper cab that contains an elevated bunk in a sleeper compartment of the cab.

### BACKGROUND OF THE INVENTION

A sleeper cab is one type of truck cab that is produced by truck manufacturers. For any of various reasons, some truck drivers may prefer to travel with a partner who may or may not share driving responsibility. Because of commercial demands that are imposed on long haul professional drivers, one of two partners who share driving responsibility may drive while the other sleeps in the cab bunk, which is typically an upper bunk at the rear of the cab. Some production trucks now have upper and lower bunks for each of two partners, allowing both to sleep while their truck is parked. Ingress to and egress from an upper bunk is typically via a step ladder.

A survey of some truckers undertaken by the inventors has disclosed that a significant number consider the task of climbing into and out of an upper sleeper cab bunk via a step ladder uncomfortable and/or inconvenient in at least some respects. Driver age is a factor in the degree of discomfort with older drivers more likely to find the task more uncomfortable than younger ones, even to the point of difficulty because significant upper body strength is typically required for climbing up into a bunk, and full body weight may have to be borne at least temporarily on one knee during the process.

Consequently, it is believed that improvements that can facilitate ingress to and egress from an upper sleeper cab bunk would be beneficial, especially when statistics show a trend of increasing average age for professional truck drivers. Moreover, if such improvements can be integrated with other components typically found in a sleeper cab, certain advantageous synergies can result.

### SUMMARY OF THE INVENTION

Generally speaking, the present invention relates to a novel arrangement for a set of stairs that enable a person to step up into an upper sleeper cab bunk instead of climbing up a ladder.

The set of stairs associates with a cabinet that provides storage space for personal possessions of a truck driver, and a passenger or partner, and/or equipment that is useful in operating the truck. The association of the set of stairs with the cabinet allows the stairs to nest in a non-deployed position inside the cabinet when not in use, yet to be easily pulled out from the cabinet to allow a person to climb up and down them for getting into and out of an upper bunk.

In one embodiment of the invention, the set of stairs carries with it one or more sliding drawers. In another embodiment, the cabinet, instead of the set of stairs, has one or more sliding drawers that stay with the cabinet when the stairs are slid out for use.

The invention addresses potential safety-related concerns, such as might be considered in the event of a collision. Because the set of stairs is substantially outside the cabinet interior when deployed for use, the disclosed embodiments of the invention comprise certain features that provide reasonable restraint of the deployed set of stairs in case of an accident so that the stairs do not become the source of a second collision inside the cab.

Nominal restraint for the stairs is provided by a two-rail, floor-mounted track system on which the stairs can slide into and out of the cabinet. A particular type of track, such as RollOn's “Easy Rail” system, is preferred because its inherent design prevents the set of stairs from separating and coming out of the rails as a result of certain unusual loads, such as might be experienced during a collision. This particular floor-mounted track system uses roller bearings to facilitate movement of the set of stairs into and out of the cabinet, an important consideration when the truck is parked on an inclined surface. The rails extend from the interior of the cabinet and out into the interior cab space in the sleeper compartment. They are mounted so as not to protrude in any significant way and while they are exposed, they are not prominent and can be covered by brushes to resist intrusion of dirt and foreign objects. The rails ensure facile linear motion of the set of stairs even though a person moving them may exert pulling or pushing force a significant distance above the floor that also creates a torque moment about the floor.

Drawers occupy open drawer spaces provided either on the interior of the set of stairs in one embodiment or on the interior of the cabinet in another so that there is no significant interior space lost by providing the set of stairs for climbing into and out of the upper bunk. The drawers and the set of stairs can be pushed into and pulled out from the cabinet independently of each other. By allowing the set of stairs to be pulled out without also pulling the cabinet-mounted drawers out with them, as in one of the two embodiments, the pulling force can be smaller because the weight of the drawers and their contents remain borne by the cabinet, not by the set of stairs.

Possible impact of the drawers and stairs during normal use and in the event of a collision is another concern that is addressed by the present invention. The cabinet is mounted directly to the floor of the cab. When the drawers are mounted for sliding in and out on the cabinet, they are mounted in a manner that is without interference with the stairs. When the drawers are mounted for sliding in and out on the set of stairs, they are separated from the cabinet by the set of stairs, and the set of stairs can freely slide in and out of the cabinet.

In order to provide increased lateral stability of a drawer should a collision occur while the drawer is open, a certain type of drawer slide, specifically a full extension drawer slide, such as the Accuride C3732-16P drawer slide, is preferred. Such a drawer slide allows easy access to items that may be in the rear of an open drawer and maintains desired structural integrity of the drawers and cabinet. The slide also possesses a slim profile that allows for the largest possible drawer to fit in the cabinet drawer space. Each drawer is supported by two slides, one at each side, and can be constructed to provide a capacity for holding up to 200 pounds.

While the cabinet could have open storage space instead of drawers, the presence of drawers is believed to allow the driver and passenger to better organize their belongings. Moreover, drawers are better suited than open spaces for keeping stored items in the cabinet. Not all the cabinet space need have drawers; some open space can be left as closet space to allow for hanging items such as clothes on a clothes bar.

In order to prevent the drawers from unintentionally sliding out when the truck is in motion or when the set of stairs is being moved, a drawer locking system is preferably provided. For example in the embodiment where the drawers slide on the cabinet, the drawer locking system includes clasps on the drawers and a rod attached to the back of the cabinet. When a drawer is fully closed, the rod is forced into the clasp. The added interference of the rod and clasps will keep the drawers in place when closed. When a drawer is to be opened, additional force is required to pull the rod out of the clasp. Once free, a drawer will slide without any interference.

The inventive arrangement also includes a locking system for releasably locking the set of stairs both in non-deployed position inside the cabinet and in deployed position. The locking system that includes a handle that is used to unlock the set of stairs and once unlocked, either push or pull them in one continuous convenient motion as will be explained at length hereinafter.

The locking system is carried by the set of stairs, except for features that are provided in an adjacent cabinet wall, specifically lock plates, into which a lock pin of a locking mechanism fits to lock the set of stairs in deployed and non-deployed positions. The handle is located at the front of the stairs and is accessible both from the floor as well as from the elevated bunk.

The locking mechanism is located on the interior of the set of stairs at the rear. The handle is exterior to the stairs and attached to a vertical shaft that is located at the front of the set of stairs and extends from inside the set of stairs through a hole in the top step to the handle. The shaft is turned about its own long axis by pushing or pulling on a grasping portion of the handle that is disposed off center to the shaft axis.

A rod, or link, couples the turning motion of the shaft to the locking mechanism to operate the lock pin, causing the lock pin to retract from a lock plate in a direction that is transverse to the direction in which the set of stairs move into and out of the cabinet. Retraction of the lock pin is accomplished via an interaction between posts on the lock pin and cam grooves in a rotor that turns within the locking mechanism in correlation with the turning of the shaft by the handle by virtue of the rod coupling the shaft motion to the locking mechanism.

The cam grooves are symmetric in a way that causes the fully extended lock pin to retract both when the handle is turned 90° clockwise from a center, or home, position and when the handle is turned 90° counterclockwise from the center position. By allowing both directions of turning to unlock the set of stairs, the locking system allows a person's natural pulling or pushing action on the handle to initially unlock the stairs and then either pull them out from the cabinet from non-deployed position or push them into the cabinet from deployed position. A spring in the locking system biases the system toward the locked condition so that when a person releases the handle with the set of stairs in either the deployed position or the non-deployed position, the lock pin automatically locks the stairs.

A final weight of about 56 pounds for the set of stairs can require as little as 6.8 pounds of force even on a 7 degree incline. Once the stairs have been pulled out and locked into place, the steps present a 15 inch width to a person climbing up or down them, a dimension the inventors consider adequate for ascent and descent. This width also takes into account the necessity for the stairs to fit into the cabinet, which in the interior arrangement of the illustrated cab is located adjacent an end of the bunk with the cabinet back against a side wall of the cab.

A step depth of around 12 inches is considered appropriate when certain ergonomic factors are taken into account. Because a person is likely to turn around on the top step in order to sit on the bunk, that step should have a depth larger than the lower steps. Considering the possibility that a person using the stairs may be bare-footed or wearing only stockings, it is also preferred that the individual steps have a suitable friction surface, such as friction strips.

The invention also addresses potential concerns about apparent loss of storage space. While the space devoted to the cabinet is occupied by a refrigerator in some truck models, the benefits of the cabinet/drawer/stair system of the present invention may outweigh the loss of refrigerator space in a significant number of minds. Not all large trucks necessarily have a refrigerator in that location, and many have no refrigerator at all.

While some storage space may be lost due to the presence of the stairs, the volume of the stair material is rather small, and can be as minimal as about one cubic foot.

Because the presence of drawers affords individuals the opportunity for better organizing their belongings and making them easier to find, the invention may encourage drivers to travel in pairs, and that could reduce delivery time of goods to customers, and possibly increase the number of individuals that want to be a truckers if a friend, family member, or partner can accompany them on long hauls.

The technological factors of better ergonomics (which come inherently with the introduction of steps), storage with improved utility (as discussed), and concern for the safety and well-being of the truck driver are embodied in principles of the invention.

Not having to store personal items in overhead compartments creates a more homelike atmosphere. The inventive stair system allows the stairs to be moved out of the way and essentially out of sight when not used, unlike a ladder or permanent footholds that are commonly present.

Because the steps provide larger areas on which a person can step, the necessity for precise foot placement is avoided. Furthermore, the steps allow a person to maintain his/her center of gravity over a step while also providing the option of standing on both feet on the same step simultaneously. The added depth of the top step allows the user to easily turn around to facilitate entry into and exit from the bunk.

The flat horizontal top of the cabinet provides continued use as a platform for objects such as a television or appliance.

A general aspect of the invention relates to a truck comprising a sleeper cab having a bunk that is elevated from a floor of the cab. A cabinet is adjacent an end of the bunk. A track runs on the cab floor from inside the cabinet to outside the cabinet. A set of stairs are movable along the track from a non-deployed position inside the cabinet to a deployed position that allows a person to ascend and descend the stairs for climbing up into and climbing down from the bunk.

More specific aspects relate to various features that have been discussed above and will be described in more detail below.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a perspective view partially cut away to show the interior of a sleeper cab of a highway truck that has a pullout step system that embodies principles of the present invention.

FIG. 2 is a perspective view of a first embodiment of step pullout system that embodies principles of the present invention and shows the steps in non-deployed position.

FIG. 3 is a view like FIG. 2 but with the steps in deployed position.

FIG. 4 is an enlarged fragmentary perspective view of a portion of FIG. 3 showing more detail.

FIGS. 5, 6, and 7 are respective front, side, and top views of a cabinet base that can be seen in FIG. 2.

FIGS. 8, 9, and 10 are respective front, side, and top views of a set of stairs that are shown in FIGS. 2 and 3.

FIGS. 11, 12, and 13 are respective front, side, and top views of a top cabinet section that can be seen in FIGS. 2 and 3.

FIGS. 14, 15, and 16 are respective front, side, and top views of a drawer that can be seen in FIG. 2.

FIG. 17 is an enlarged fragmentary view showing a locking system for locking the set of stairs in deployed and non-deployed positions and that includes a handle that is used both to unlock the set of stairs and to move them between deployed and non-deployed positions.

FIG. 17A is a perspective view of the locking system by itself apart from the stairs.

FIG. 18 is a perspective view of a locking mechanism of the locking system.

FIG. 18A is a perspective view for showing the interior of the locking mechanism.

FIGS. 19, 20, and 21 are respective top, front, and side views of one of the parts of the locking mechanism of FIG. 18.

FIGS. 22, 23, and 24 are respective top, front, and side views of a second part of the locking mechanism of FIG. 18.

FIGS. 25, 26, and 27 are respective front, side, and top views of a third part of the locking mechanism of FIG. 18.

FIG. 28 is a perspective view of a second embodiment of step pullout system embodying principles of the present invention showing the set of stairs in non-deployed position.

FIG. 29 is a perspective view of the second embodiment of step pullout system looking in a different direction still with the stairs in non-deployed position but with a drawer open.

FIG. 30 is a perspective view looking in the same direction as FIG. 28, but with the stairs in deployed position.

### DESCRIPTION OF THE PREFERRED EMBODIMENT

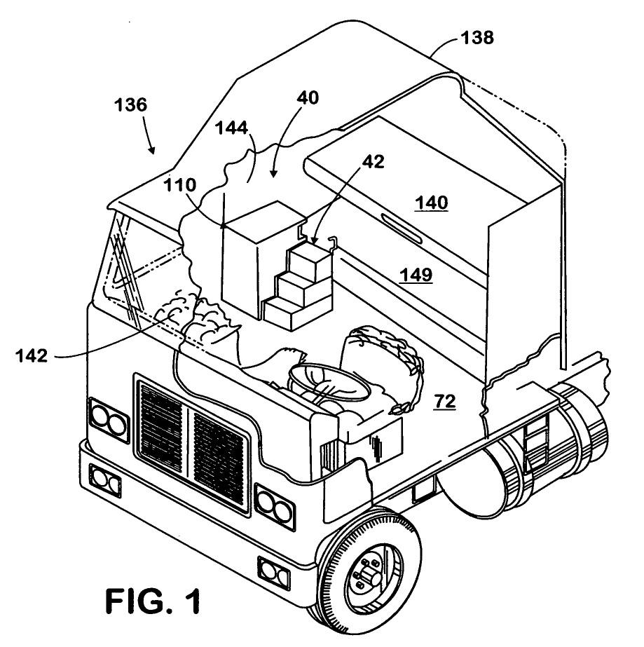

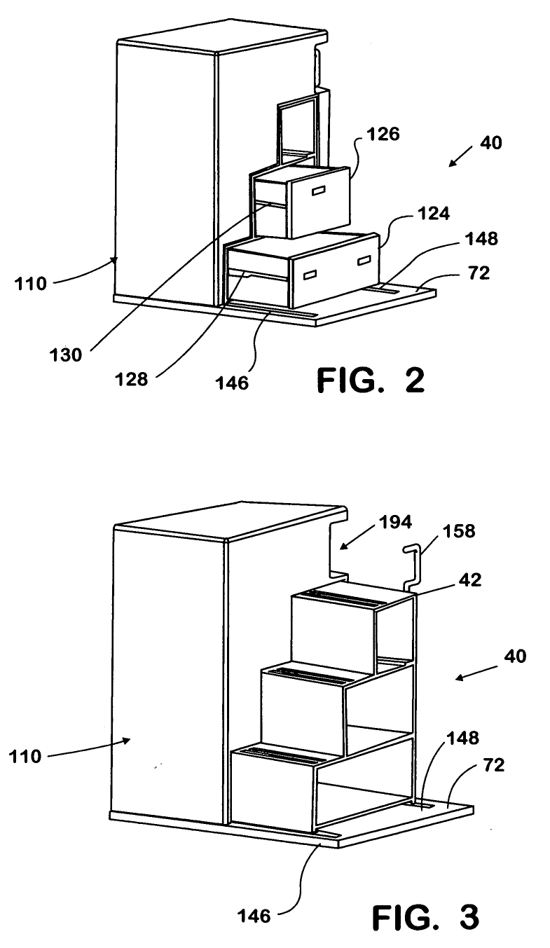

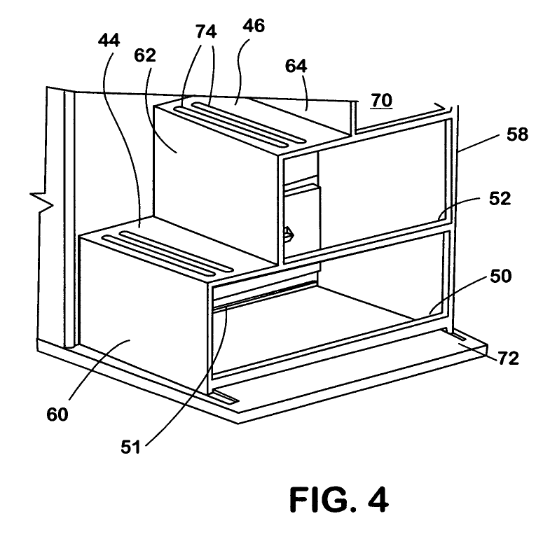

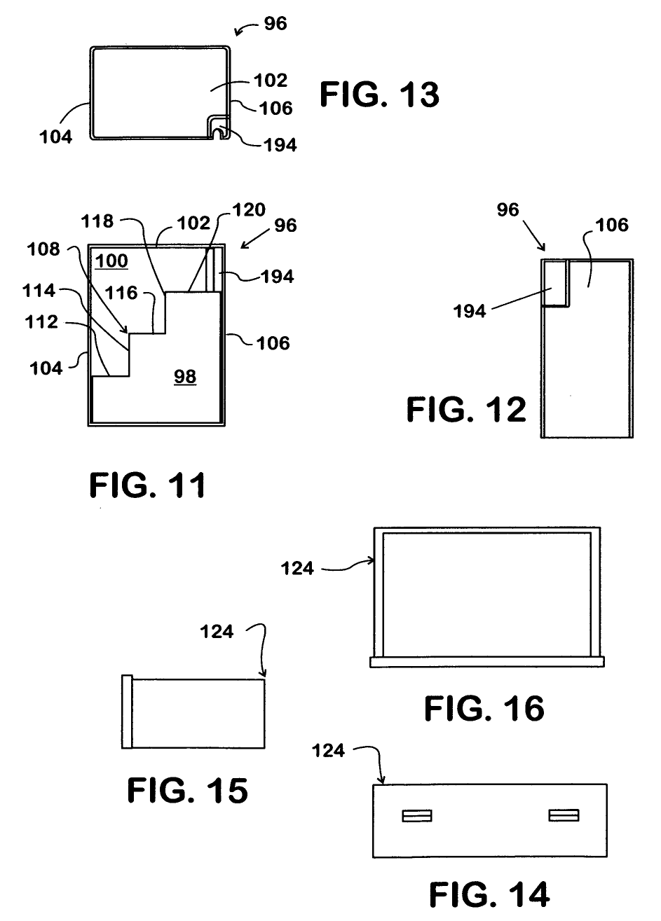

A first embodiment of pullout step system 40 embodying principles of the present invention is presented in FIGS. 1-27 to show a set of stairs 42 that can be selectively placed in a non-deployed position shown in FIG. 2 and a deployed position shown in FIGS. 1 and 3.

Stairs 42 comprises a module (see also FIGS. 8-10) that comprises first, second, and third solid rectangular steps, 44, 46, 48 respectively, in ascending order, solid rectangular risers 60, 62, 64 and a solid rectangular side wall 58.

A bar 50 is disposed at the front of the module as viewed in FIGS. 8 and 9 to join the bottom of riser 60 to the bottom of wall 58. A bar 52 is disposed at the front of the module to join the junction of step 44 and riser 62 to wall 58. Step 46 is the left hand end portion of a horizontal wall 54 that continues to the right to join with wall 58, and riser 64 is supported on that horizontal wall. Step 48 joins the top of riser 64 to side wall 58. The arrangement of steps, risers, bars, and side wall provides the module with three rectangular-shaped interior spaces 66, 68, 70 that are closed on the sides but open at front and rear. On the interior of the module, the top of space 66 is open to the bottom of space 68, but the top of space 68 is closed to the bottom of space 70. The bottom of space 66 is open to the cab floor 72.

Additional features include a suitable friction surface on each step, shown by friction strips 74, and vertical flanges 76, 78, 80, whose purpose will be explained later, extending a short distance upward from the rear edge of respective steps as viewed in FIGS. 8 and 9.

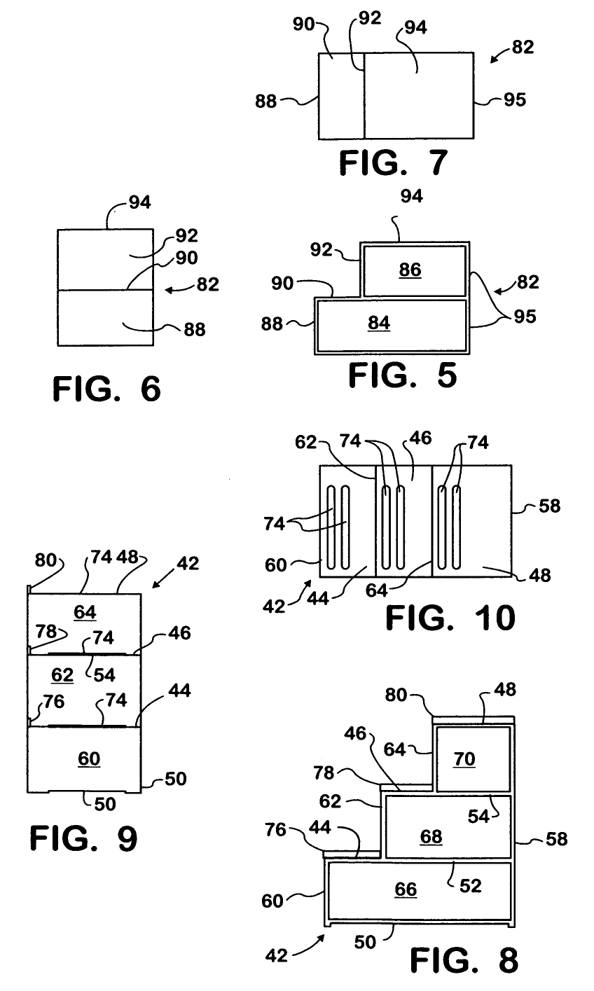

System 40 also comprises a cabinet base 82 that is shown by itself in FIGS. 5-7 and that comprises structure that forms two rectangular-shaped interior spaces 84, 86 that are open at least at the front and optionally at the rear. The specific base shown here has at least solid walls 88, 90, 92, 94, and 95, with wall 90 extending to wall 95.

System 40 further comprises a top cabinet section 96 that is shown by itself in FIGS. 11-13 and that comprises structure that forms two interior spaces 98, 100. At least space 98 is open at the front and optionally at the rear. This particular top section has the two spaces open at both front and rear and has solid walls 102, 104, 106, 108.

The two cabinet sections 82, 96 are arranged to vertically capture stairs 42 between themselves while allowing the stairs to slide into and out of a cabinet 110 cooperatively formed by the two cabinet sections.

Wall 108 is a stepped wall that is substantially congruent to the three steps 44, 46, and 48 and the two risers 62, 64. When stairs 42 are in non-deployed position inside cabinet 110, step 44 is disposed directly below a horizontal portion 112 of wall 108, step 46 is disposed directly below a horizontal portion 116 of wall 108, step 48 is disposed directly below a horizontal portion 120 of wall 108, riser 62 is disposed directly to the right of a vertical portion 114 of wall 108, and riser 64 is disposed directly to the right of a vertical portion 118 of wall 108.

When stairs 42 are in non-deployed position inside cabinet 110, step 44 directly overlies wall 90, the horizontal wall 54 that contains step 46 directly overlies wall 94, and wall 58 directly faces the inside of wall 95. The stepped wall 108 cooperates with top and side walls of the top cabinet section to provide space within the interior of the top cabinet section. although the drawing Figures show the front of such storage space closed, it can be left open and provided with drawers, shelves, and/or a clothes closet.

Space 84 provides a drawer space for a drawer 124, and space 86, a drawer space for a drawer 126. (See FIG. 2.) Drawer 124 is shown by itself in FIGS. 14, 15, and 16. The drawers are mounted on base 82 by drawer slides, having elements such as 128, 130 in FIG. 2, that are attached to the drawer sides and that slide on elements mounted on the confronting vertical walls of the base. Drawers 124, 126 are spaced vertically apart at the front so that bar 52 can fit between them when the stairs are in non-deployed position. It can be seen that drawer space 84 and its drawer 124 underlie all three steps 44, 46, 48, and a drawer space 86 and its drawer 126 overlie drawer space 84 and its drawer 124 and underlie the second and third steps 46, 48.

FIG. 1 shows a truck 136 having a sleeper cab 138 with a bunk 140 that is elevated from floor 72 arranged with its length running in the direction of the cab's width at the rear of the cab. Cabinet 110 is mounted on floor 72 behind a passenger seat 142 with the cabinet rear, or back, disposed against a side wall 144 of the cab. Base 82 is fastened to floor 72. A track that comprises floor-mounted parallel rails 146, 148 (See FIG. 2.) supports stairs 42 so that the stairs are free of interference with base 82 vertically and horizontally. The track length runs in the direction of the cab's width parallel to the length of bunk 140 from inside the cabinet and ends in the open interior of the cab.

A lower bunk 149 is beneath bunk 140. It is alongside bunk 149 that stairs 42 slide into and out of cabinet 110. FIG. 1 shows stairs 42 in deployed position (also shown in FIG. 3) that allows a person to ascend and descend them for climbing up into and climbing down from bunk 140. It should be noticed that drawers 124, 126 stay behind in base 82 when stairs 42 are slid out of cabinet 110 to the deployed position. In non-deployed position of the stairs, drawers 124, 126 can be opened and closed free of interference with the stairs, as shown by FIG. 2.

With the set of stairs deployed, inner portions of the three steps effectively remain inside the cabinet. The weight of the stairs and a person using them must be transferred to floor 72 in some way. Some of that weight is transferred through wall 58 and rail 148, and through riser 60 and rail 146. The remainder of the weight is transferred by the inner portion of step 44 that effectively remains inside the cabinet and bears on wall 90, particularly when the weight of a person is on the stairs, and possibly also by the inner portion of step 46 and its wall, bearing on wall 94. With the lower surfaces of steps 44 and 46 confronting upper surfaces of walls 90 and 94, some limited sliding of the former on the latter as the stairs are slid out of and into the cabinet is tolerable in order for the hidden inner portions of the two steps to be supported when the stairs are used.

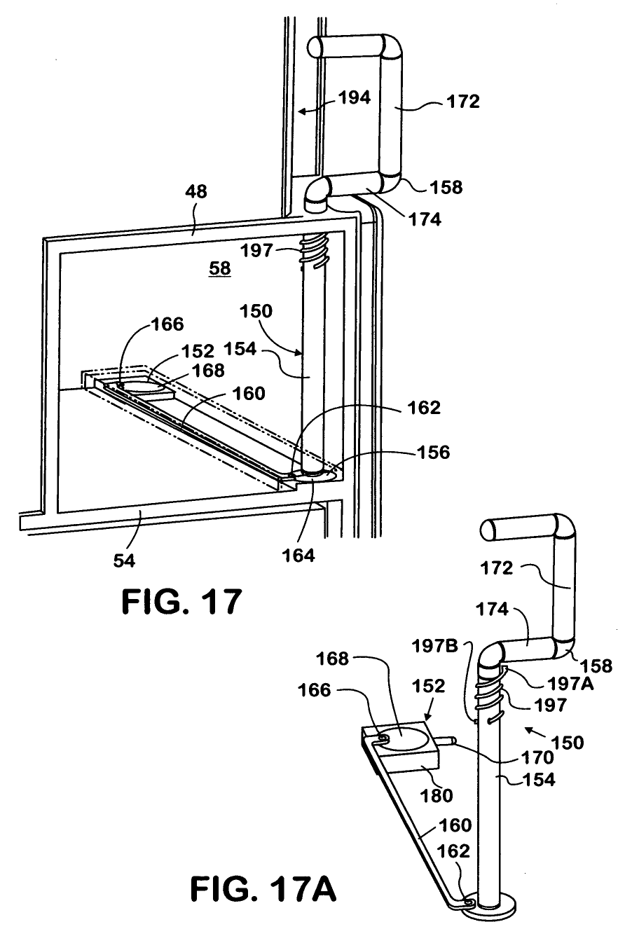

A locking system 150, shown in various Figures, and especially in FIGS. 17 through 27, releasably locks stairs 42 in both deployed and non-deployed position. Locking system 150 comprises a locking mechanism 152 mounted on wall 54 inside of wall 58 at the rear of the stair module. A vertical shaft 154 at the front of the interior of the stair module alongside wall 58 is journaled for rotation about is own axis on an assembly 156 mounted on wall 54 to the front of locking mechanism 152. Shaft 154 extends through a hole at a front corner of step 48 where a handle 158 attaches to the shaft end. A rod, or link, 160 connects a short post 162 on a rotor 164 in assembly 156 that can be turned by shaft 154 to a short post 166 on a rotor 168 of locking mechanism 152.

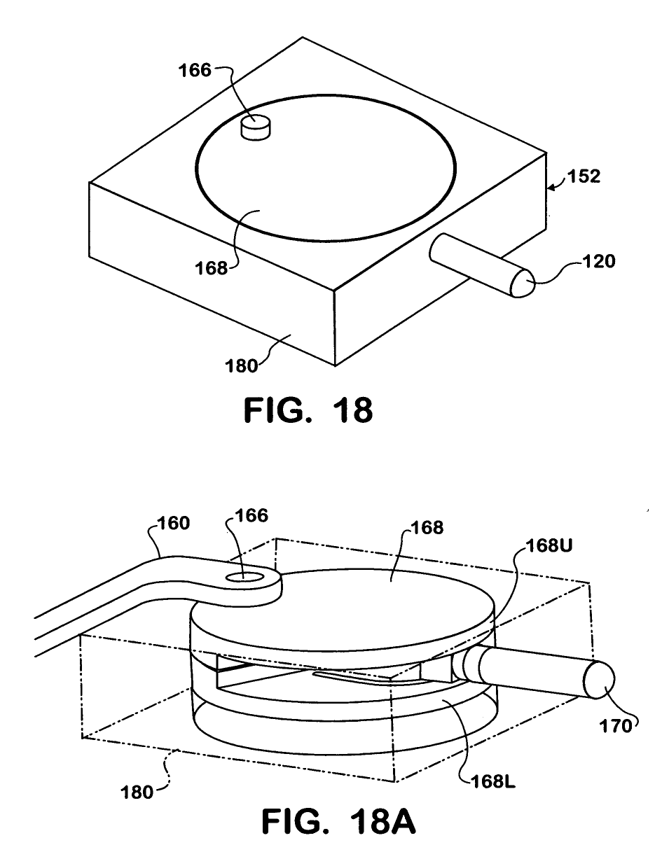

FIGS. 17 and 17A show locking system 150 in locking position that places a lock pin 170 of mechanism 152 in a maximally extended position as can be seen in FIGS. 17A, 18, and 18A. With stairs 42 positioned in deployed position at their maximum distance out from cabinet 110 on rails 146, 148, the distal end of maximally extended lock pin 170 protrudes through a hole in wall 58 to lodge in an aligned hole in a lock plate (not shown) that is affixed to wall 106 of the top cabinet section to thereby lock stairs 42 stationary on the track. With stairs 42 fully slid into cabinet 110, the distal end of pin 170 can protrude through the hole in wall 58 to lodge in another aligned hole in another lock plate (not shown) that is also mounted on 106 to thereby lock the stairs stationary on the track in non-deployed position.

Handle 158 is essentially a hand crank. It has a vertical grasping portion 172 that joins with shaft 154 via a horizontal lever arm portion 174. The extent to which lock pin 170 extends from mechanism 152 is controlled by the extent to which shaft 154 is turned by handle 158. With handle 158 in the position shown in FIGS. 3 and 17, lock pin 170 is maximally extended. If handle 158 is grasped and turned 90° either clockwise or counterclockwise from the FIGS. 3 and 17 position, pin 170 will be maximally retracted. With pin 170 maximally retracted, it cannot lock the stairs to either lock plate.

Rotor 164 turns in correlation with the turning of shaft 154 by handle 158. Link 160 couples the motion of rotor 164 to rotor 168 so that rotor 168 also turns in correlation with the turning of shaft 154 by handle 158.

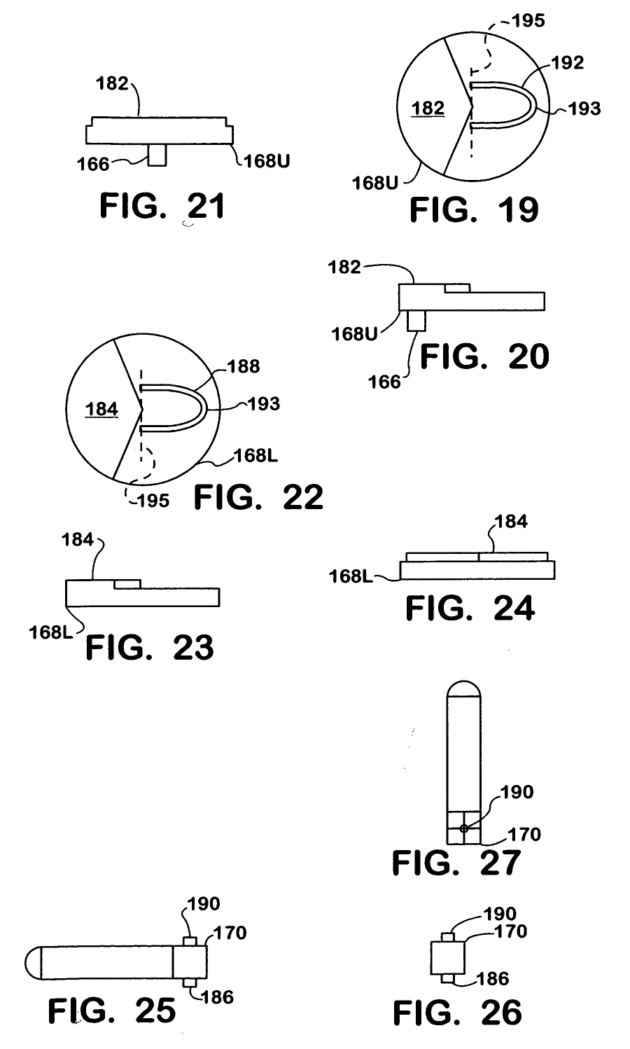

How rotor 168 extends and retracts lock pin 170 is explained with reference to FIGS. 19-27. A square casing 180 of locking mechanism 152 has a hole in one side that guides pin 170 for linear extension and retraction. Casing has a circular cavity in which rotor 168 is disposed. Rotor 168 has an upper part 168U and a lower part 168L. It is part 168U that contains post 166.

The rotor parts 168U, 168L mutually abut at respective identical plateaus 182, 184 that provide space that allows the parts to cooperate in capturing lock pin 170 between them. With the two parts abutted, a post 186 on the bottom of lock pin 170 at the pin's proximal end fits in a cam groove 188 on an interior face of part 168L. Similarly a post 190 on the top of lock pin 170 at the pin's proximal end fits in a cam groove 192 on an interior face of part 168U. The two cam grooves are identical and are in circumferential registration. Each groove has symmetrical half segments that merge at a maximum radial distance 193 from the center of its circular rotor part. Each half segment ends at a minimum radial distance from the center of its rotor part. The minimum radial distances are on opposite halves of a common diameter 195 of the rotor. The maximum radial distances 193 are at right angles (90°) to that common diameter.

With lock pin 170 so constrained between the two rotor parts 168U, 168L and with posts 186, 190 located in the cam grooves at the maximum radial distance 193, the lock pin is maximally extended, corresponding to the position of parts shown in FIG. 17.

Turning rotor 168 in either direction within casing 180 will cause the cam grooves to also turn. As posts 186, 190 ride in the respective cam grooves, the camming action of the grooves on the pin posts 186, 190 causes lock pin 170 to retract. Full retraction occurs when the rotor has turned 90° in either direction.

The process of how the association of handle 158 with locking system 150 enables stairs 42 to be operated can now be fully understood. The wall structure of top cabinet section 96 has an exterior recess 194 at an upper corner that is open toward the bunk on one side and toward the interior of the cab on an adjoining side. Handle 158 is disposed within recess 194, and hence doesn't noticeably protrude when the stairs are in non-deployed position, but it can still be conveniently grasped.

With the stairs locked in the non-deployed position, a person grasping handle 158 and pulling it toward himself or herself, will initially turn shaft 154 and retract lock pin 170. Once lock pin 170 clears the corresponding lock plate, the stairs become unlocked, enabling them to be slid on rails 146, 148. Consequently with the stairs still non-deployed but now unlocked, continued pulling on handle 158 will begin moving the stairs out of the cabinet along rails 146, 148. When the stairs have been placed in deployed position, returning handle 158 to the position of FIG. 17 will cause lock pin 170 to extend and lock the stairs to the other lock plate. For automatically locking the stairs upon release of the handle, a spring, such as a torsion spring 197, can be employed in association with the locking system to inherently bias the lock pin toward maximum extension. The spring is fully relaxed when lock pin 170 is fully extended.

A tail 197A at the upper end of spring 197 fits into a hole in wall 48 to constrain that end of the spring on the stairs. A tail 197B at the lower end of the spring runs diametrically through shaft 154. Coils of the spring are disposed around the outside of the shaft.

With the stairs locked in the deployed position, a person grasping handle 158 and pushing it away from himself or herself, will initially turn shaft 154 and retract lock pin 170. The spring coils will unwind slightly as the shaft is turned through 90°. Once the lock pin clears the lock plate, the stairs become unlocked, enabling them to be slid along the track. Consequently with the stairs still deployed but now unlocked, continued pushing will begin moving the stairs along rails 146, 148 back toward the cabinet. When the stairs have been fully returned to the cabinet, returning the handle to the position of FIG. 17 will cause lock pin 170 to extend and lock the stairs to the corresponding lock plate. Upon handle 158 being released, spring 197 relaxes to automatically extend the lock pin and return the handle to the FIG. 17 position.

When the handle is pulled instead of pushed, the coils of spring 197 wind slightly and provide torque that will return the spring to relaxed condition, and handle to FIG. 17 position, upon release of the handle.

Although the locking system, with the exception of handle 158 is contained within the interior space 70, it is desirable that the moving elements in that space be covered when the front of the space is left open. FIG. 17 shows a cover in phantom for covering assembly 156, mechanism 152, and rod 160.

The intent of flanges 76, 78, and 80 is to interfere with structure of the top cabinet section so as to prevent the set of stairs from coming straight out of the cabinet if the stairs run off the end of the track for any reason. The interference would occur only if the stairs were to move further out of the cabinet beyond the deployed position.

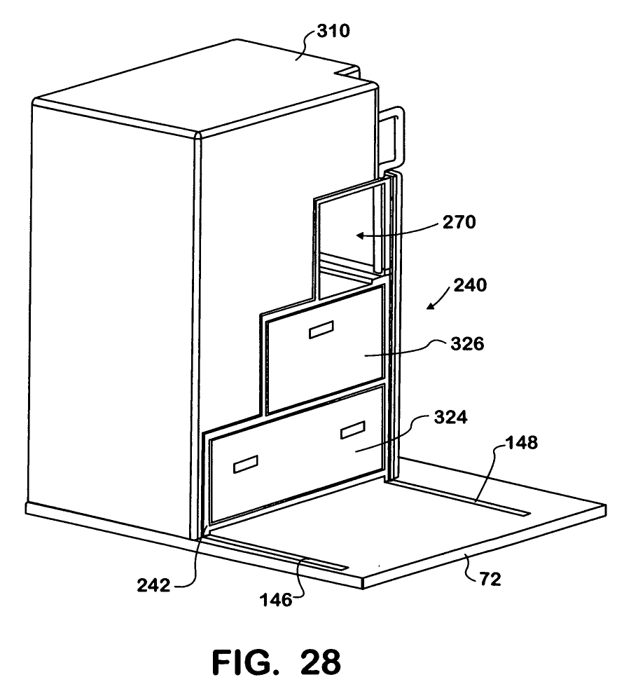

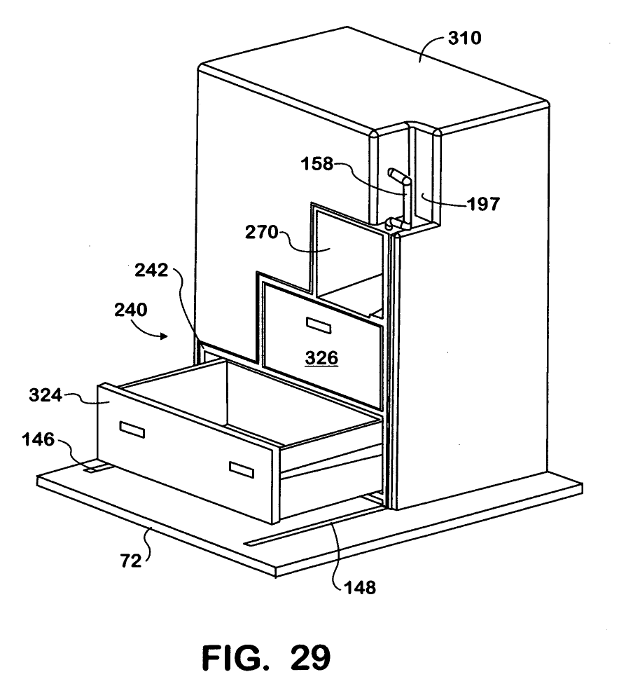

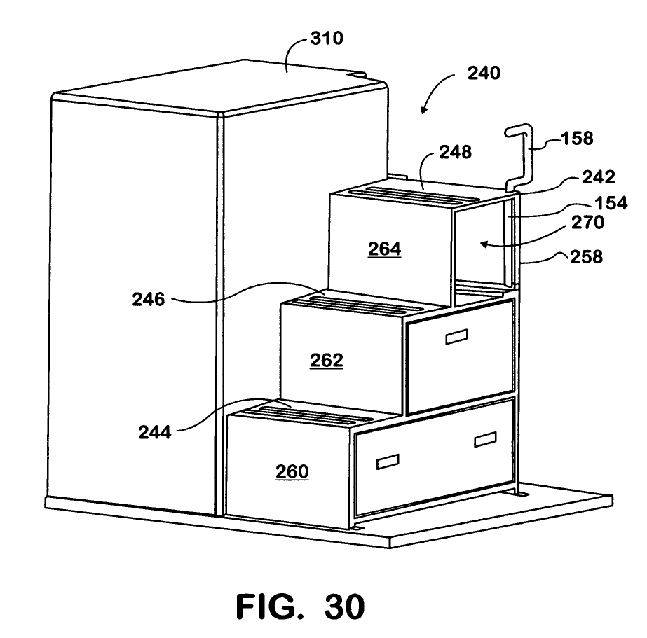

A second embodiment of pullout step system 240 embodying principles of the present invention is presented in FIGS. 28-30. Like system 40, system 240 has a set of stairs 242 that can be selectively placed in a non-deployed position inside a cabinet 310 shown in FIGS. 28 and 29 and a deployed position shown in FIGS. 30 through 32.

Stairs 42 comprises a module 243 that comprises first, second, and third solid rectangular steps, 244, 246, 248 respectively, in ascending order, solid rectangular risers 260, 262, 264 and a solid rectangular side wall 258. Steps 244 and 246 are external portions of solid horizontal walls that extend through the interior of the module to join to side wall 258.

The arrangement provides the module with three rectangular-shaped interior spaces that are closed on the sides but open at front and rear.

Each step has a suitable friction surface and vertical flanges that cannot be seen but are like and function in the same way as flanges 76, 78, 80 of the first embodiment.

Drawers 324, 326 are arranged to slide in and out of a first and second of the three spaces via drawer slides in the same way that drawers 124, 126 can slide on base 82 of the first embodiment. Because the drawers 324, 326 are mounted for sliding on the stair module, they will move with the stairs. The third space 270 is open at the front.

With the stairs not deployed, as in FIGS. 28 and 29, the drawers can be opened and closed. Likewise with the stairs deployed as in FIG. 30, the drawers can still be opened and closed.

The track and the locking system of the second embodiment are like that of the first embodiment. The cabinet 310 basically fits over the set of stairs and is fastened to the floor at the bottom of its side walls or at the back to the cab side wall.

While a presently preferred embodiment of the invention has been illustrated and described, it should be appreciated that principles of the invention apply to all embodiments falling within the scope of the invention that is defined as follows.

What is claimed is:

1. A truck comprising:
a sleeper cab having a bunk that is elevated from a floor of the cab;
a cabinet adjacent an end of the bunk;
a track on the floor running from inside the cabinet to outside the cabinet;
a set of stairs that are movable along the track from a non-deployed position inside the cabinet to a deployed position that allows a person to ascend and descend the stairs for climbing up into and climbing down from the bunk.

2. A truck as set forth in claim 1 wherein the set of stairs comprises at least one drawer space and a drawer that can be slid into and out of the drawer space in the same direction as the set of stairs moves on the track.

3. A truck as set forth in claim 2 wherein the set of stairs comprises first, second, and third steps in ascending order, a first drawer space containing a first drawer underlying all three steps, and a second drawer space containing a second drawer overlying the first drawer space and underlying the second and third steps.

4. A truck as set forth in claim 3 further comprising a locking mechanism that releasably locks the set of stairs in non-deployed position and is released by operation of a handle that a person grasps and turns in advance of pulling on the turned handle to move the released set of stairs toward deployed position along the track.

5. A truck as set forth in claim 1 wherein the cabinet comprises a stationary floor-mounted base containing at least one drawer space and a drawer that can be slid in and out of the drawer space in the same direction as the set of stairs moves on the track, the at least one drawer space and drawer underlying at least one step of the set of stairs when the set of stairs is in non-deployed position.

6. A truck as set forth in claim 5 wherein the set of stairs comprises first, second, and third steps in ascending order, and the cabinet base comprises a first drawer space containing a first drawer underlying all three steps when the set of stairs is in non-deployed position, and a second drawer space containing a second drawer overlying the first drawer space and underlying the second and third steps when the set of stairs is in non-deployed position.

7. A truck as set forth in claim 6 wherein the cabinet further comprises a top cabinet section that cooperates with the base to vertically enclose the set of stairs when the latter are in non-deployed position.

8. A truck as set forth in claim 7 wherein the top cabinet section comprises a stepped wall that overlies and is substantially congruent to the steps and to risers between the steps.

9. A truck as set forth in claim 8 wherein the stepped wall of the top cabinet section cooperates with top and side walls of the top cabinet section to provide storage space within the interior of the top cabinet section.

10. A truck as set forth in claim 9 wherein the top cabinet section further comprises a horizontal top wall vertically above the stepped wall.

11. A truck as set forth in claim 7 wherein wall structure of the top cabinet section has an exterior recess at an upper corner that is open toward the bunk on one side and toward the interior of the cab on an adjoining side, and the set of stairs comprises a locking system that releasably locks the set of stairs in non-deployed position and is released by a person grasping and operating a handle to turn a shaft journaled on the set of stairs in advance of pulling the turned handle once the set of stairs has been released to pull the set of stairs toward deployed position along the track, and wherein the handle is disposed in the exterior corner recess of the top cabinet section when the stairs are in non-deployed position.

12. A truck as set forth in claim 11 wherein the locking system comprises a spring that biases a lock pin of locking mechanism in the locking system toward a locking position, and also the shaft and handle toward a center position relative to an axis about which the shaft turns, and wherein no more than 90° of turning of the shaft and handle in either direction from the center position is needed in order to unlock the set of stairs and allow it to move along the track.

13. A truck as set forth in claim 12 wherein the locking mechanism is mounted on the set of stairs more interiorly than the shaft and that is operatively coupled with the shaft, and wherein upon the handle being released after the set of stairs has been placed in deployed position, the spring is effective to force the lock pin to locking position and lock the set of stairs in deployed position.

14. A truck as set forth in claim 1 wherein the bunk is arranged with its length running in the direction of the cab's width, the cabinet is mounted on the floor with its back toward a side wall of the cab behind a seat in the cab, and the track length runs in the direction of the cab's width.

15. A truck as set forth in claim 14 wherein the set of stairs comprises first, second, and third steps in ascending order, and the third step has a depth that is greater than the depth of either the first or the second step.

16. A truck as set forth in claim 14 wherein the set of stairs comprises a locking system that releasably locks the set of stairs in both non-deployed and deployed positions and that is released to unlock the set of stairs with the set of stairs in either non-deployed or deployed position by a person grasping and operating a handle to turn a shaft journaled on the set of stairs in advance of moving the set of stairs along the track from one position to the other.

17. A truck as set forth in claim 16 wherein the shaft is arranged for turning over a range of approximately 180° by operating the handle, the locking system is placed in locking position when the shaft is approximately at the center of the 180° range of turning, and when the set of stairs is locked in non-deployed position and a person's hand grasps the handle and exerts a pulling motion that turns the shaft about 90° in one direction, the set of stairs becomes unlocked and upon becoming unlocked, begins moving toward deployed position along the track in response to sufficient pulling force, and when the set of stairs is locked in deployed position and a person's hand grasps the handle and exerts a pushing motion that turns the shaft about 90° in the opposite direction from locking position, the set of stairs becomes unlocked and upon becoming unlocked, begins moving toward the non-deployed position along the track in response to sufficient pushing force.
